(19) United States
(12) Patent Application Publication
(10) Pub. No.: US 2006/0271558 A1
(43) Pub. Date: Nov. 30, 2006

(54) Method, associated device, system, and computer program product for data management

(75) Inventors: Kaj Makela, Tampere (FI); Jaakko Lehikoinen, Hameenkyro (FI)

Correspondence Address: HARRINGTON & SMITH, LLP, 4 RESEARCH DRIVE, SHELTON, CT, 06484-6212, US

(73) Assignee: Nokia Corporation

(21) Appl. No.: 11/429,509

(22) Filed: May 5, 2006

Related U.S. Application Data
(63) Continuation of application No. PCT/FI05/00245, filed on May 30, 2005.

(51) Int. Cl. G06F 17/30

(52) U.S. Cl. 707/10

(57) ABSTRACT

A method and associated device, system, and computer program product for performing metadata-based searches of data files using particularly but not necessarily a small display and a limited user interface. In the method a user of the device selects at least one data item, which is stored in the memory of the device. The device calculates a distance between said selected data item and at least one data item of said plurality of data items, which distance is relative to the similarity of the meta-data between the selected data item and said plurality of data items. Finally the device then provides a visual symbol of said selected data item and the most similar data items of said plurality of data items on the display of the device.

The present invention relates generally to systems and methods for searching, browsing and filtering data in an electronic device and, more particularly, to method and associated device, system, and computer program product for performing metadata based searches of data files using a display and a user interface.

### BACKGROUND OF THE INVENTION

Amount of multimedia files increase rapidly together with memory resources especially in portable devices. Handling large amounts of multimedia objects is challenging. Imaging phones have penetrated to the market during a couple of recent years. Users are taking a lot of pictures with their phones. However, one area that is poorly supported today is flexible browsing and watching the multimedia content created. The user experience in this area is extremely important in order to increase the attractiveness of imaging phones.

Current development of multimedia technology and attaching the camera into phones has made still image capture, video and audio recording an everyday task. Due to this, the amount of multimedia files is ever increasing with a quick pace together with the development of mobile memory resources.

Improved technologies present the need for increased processor capacity and storage for the increasing amounts of data that may now be transmitted to a mobile device. Mobile devices have improved as storage devices, and mobile devices now provide increased storage capacity for data files such as email, email attachments, web pages, images, music, and other files such as multimedia files, which can be transmitted on 3G systems. Improved storage devices and increased storage capacities also result in increasing numbers of data files. As the number of data files on a mobile device increase, accessing a particular data file or group of data files becomes increasingly difficult, less efficient, and, eventually, prohibitive for effective use of the mobile device as a storage medium.

This problem is particularly relevant for devices with small display screens such as mobile telephones, MP3 players, personal digital assistants, and devices that represent a combination of these and other personal and wireless technologies. Because of growing storage capacities, even devices with small screens that traditionally had limited storage capacities can, nevertheless, contain large quantities of data and numbers of data files, such as media files or media items. In addition to the problem of small displays, physical and software user interfaces are typically limited on many personal and wireless devices. If the physical user interface is not going to change, the manner of using the device and associated software user interface can be changed to improve the ability to manage increasing amounts of stored data.

The multimedia objects are seldom named or stored to certain location to enable easy finding of relevant files. Because of this, the use of file metadata has become significant method in the filtering, searching and browsing of multimedia files.

Previous and existing file management systems have relied upon folder-based management with searching or filtering based upon data file characteristics such as name, date, type, and size. Other approaches have taken advantage of searching metadata fields of data files. But these file management systems rely primarily upon presenting search results in a flat list. A flat list is incapable of efficiently presenting results of data files using a small screen, limited user interface, or a combination of physical and interface limitations, particularly where large quantities of data and numbers of data files are stored on a device. Existing file management systems do not provide users with the ability to adequately identify, locate, and select a particular data file, whether for emailing or sending to another device or user, deleting the file, listening or watching the file, or any other use or activity. For example, a mobile telephone or other terminal with a built in digital camera presents a users with the practical difficulty of managing large numbers of digital images or other media files, such as movies and sound. Finding a particular image from hundreds of images that were captured or otherwise stored on a mobile device is very difficult.

### SUMMARY OF THE INVENTION

In light of the foregoing background, embodiments of the present invention provide an improved method and associated terminal, system, and computer program product for performing metadata-based searches of data files using a display and a user interface of a portable electronic device.

Embodiments of the present invention provide a system, associated device or mobile terminal, method, and computer program product for performing metadata-based searches in which content is constantly changed. This interaction supports the processes of searching, browsing and filtering.

According to an embodiment of the present invention a user selects for example one picture and on the basis of said selection other content of the browser is arranged according to the selected picture, i.e. according to a data item. The data item may represent any data, which is presentable to the user of the electronic device. After the user makes another choice, the new selection becomes a content magnet and the whole content is arranged again according to the newly selected content magnet. The function of the content magnet is to attract any possibly related content when making the search. The content magnet is based on metadata characteristics of the data files. The content magnet can be changed various times to reflect or focus the characteristics user desires for. The embodiment discloses an interaction, in which content is constantly changed. In the embodiment the content magnets, alternatively referred to as the search magnets, are utilized in searching, filtering and browsing phases. Not only results are grouped, but also nearby similarities, here called as content magnets, are used also for browsing metadata.

An embodiment of a method of the present invention comprises means for searching a data item from a plurality of data items each having at least one associated metadata item, the metadata being readable at a memory of an electronic device. In the method there is being selected at least one data item as a search criteria. Then there is calculated the relation between the metadata of said selected data item and at least one data item of said plurality of data items, and provided the user interface with a first visual symbol about the at least one selected data item and with a second visual symbol about the at least one data item of the plurality of data items so that the first and the second visual symbols are placed with respect to each other in accordance with the calculated relation.

An embodiment of a device of the present invention comprises means for searching a data item from a plurality of data items each having at least one associated metadata item, the metadata being readable at a memory of an electronic device. The device comprises selecting means for selecting at least one data item as a search criteria, calculating means for calculating the relation between the metadata of said selected data item and at least one data item of said plurality of data items, and a display for providing the user interface with a first visual symbol about the at least one selected data item and with a second visual symbol about the at least one data item of the plurality of data items so that the first and the second visual symbols are placed with respect to each other in accordance with the calculated relation.

An embodiment of a system of the present invention comprises means for searching a data item from a plurality of data items each having at least one associated metadata item, the metadata being readable at a memory of an electronic device. The system comprises selecting means for selecting at least one data item as a search criteria, calculating means for calculating the relation between the meta data of said selected data item and at least one data item of said plurality of data items, and a display for providing the user interface with a first visual symbol about the at least one selected data item and with a second visual symbol about the at least one data item of the plurality of data items so that the first and the second visual symbols are placed with respect to each other in accordance with the calculated relation.

The method and the system can be embodied as a computer program product having a computer program code for performing the steps.

In the following, the invention will be described in greater detail with reference to the accompanying drawings, in which

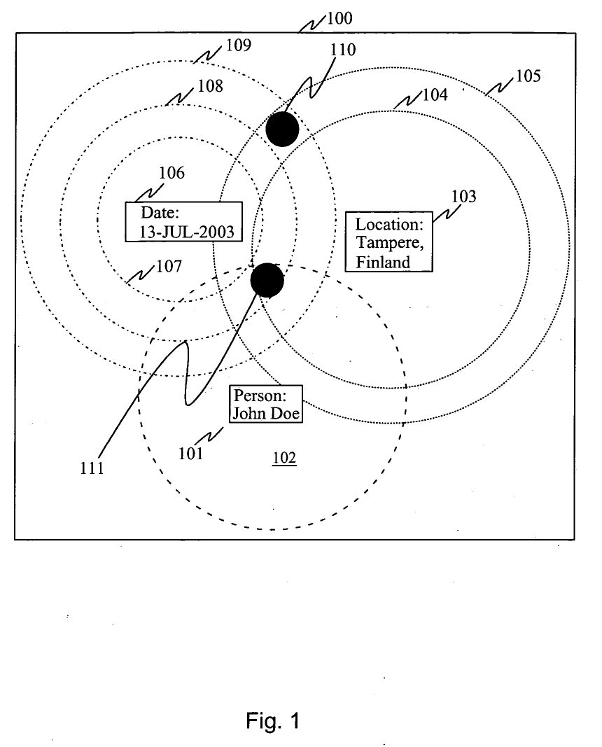

FIG. 1 illustrates a display of an electronic device showing search results of a search of data files according to an embodiment of the present invention;

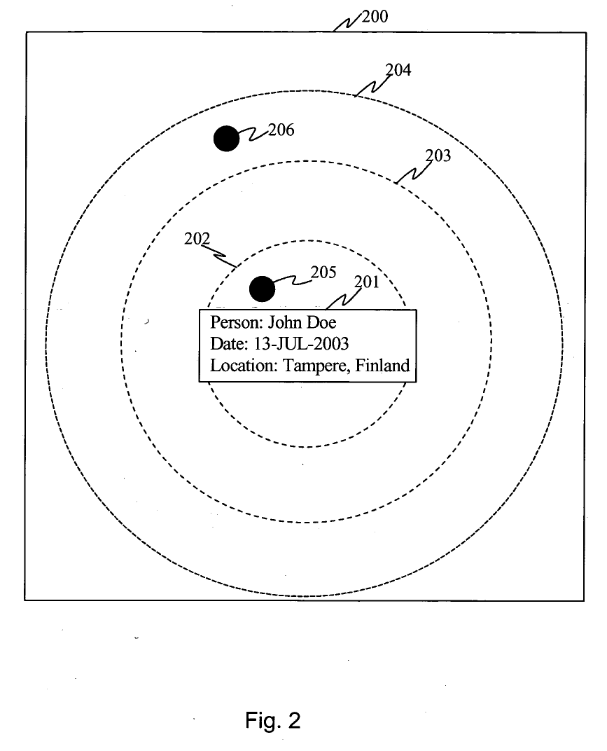

FIG. 2 illustrates is a display on an electronic device showing search results of a search of data files by an alternative way according to an embodiment of the present invention;

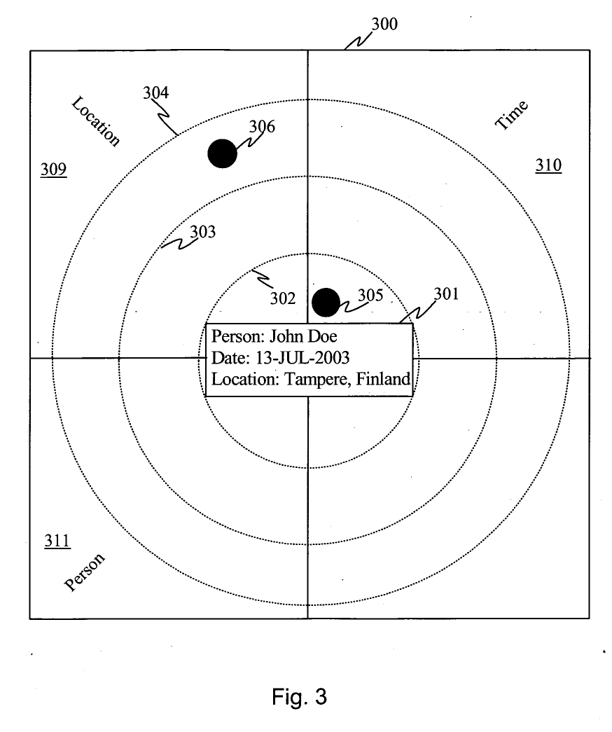

FIG. 3 illustrates is a display on an electronic device showing search results of a search of data files by an alternative way according to an embodiment of the present invention;

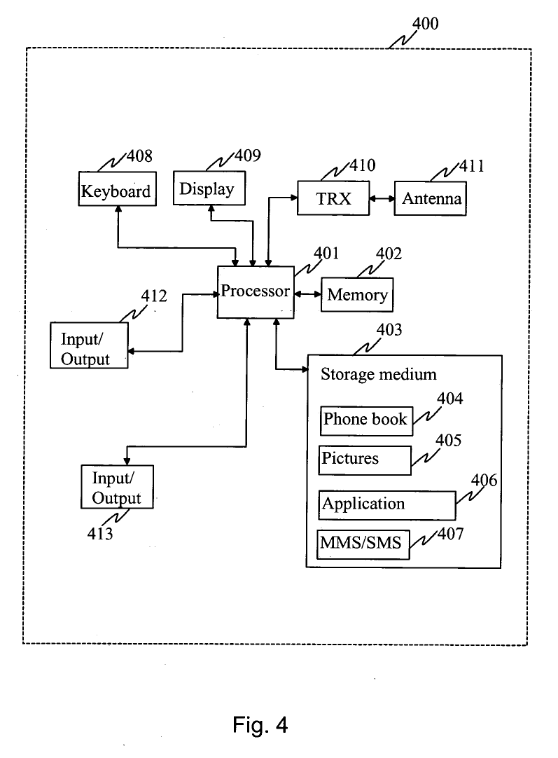

FIG. 4 illustrates a block diagram of an electronic device according to an embodiment of the invention;

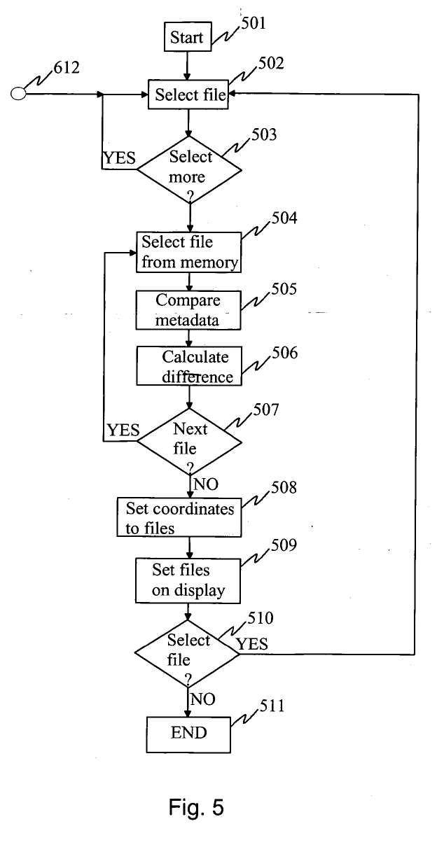

FIG. 5 illustrates a flow chart of a method according to an embodiment of the invention;

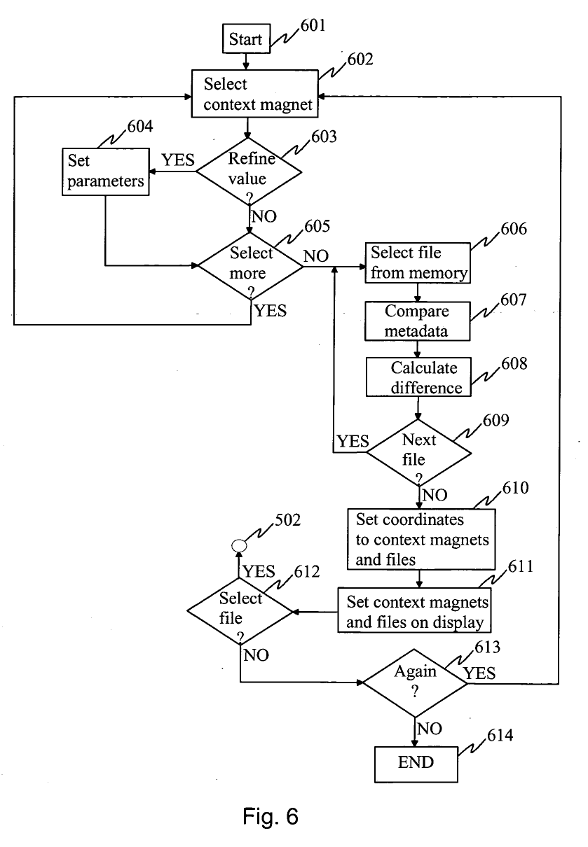

FIG. 6 illustrates a flow chart of a method according to another embodiment of the invention;

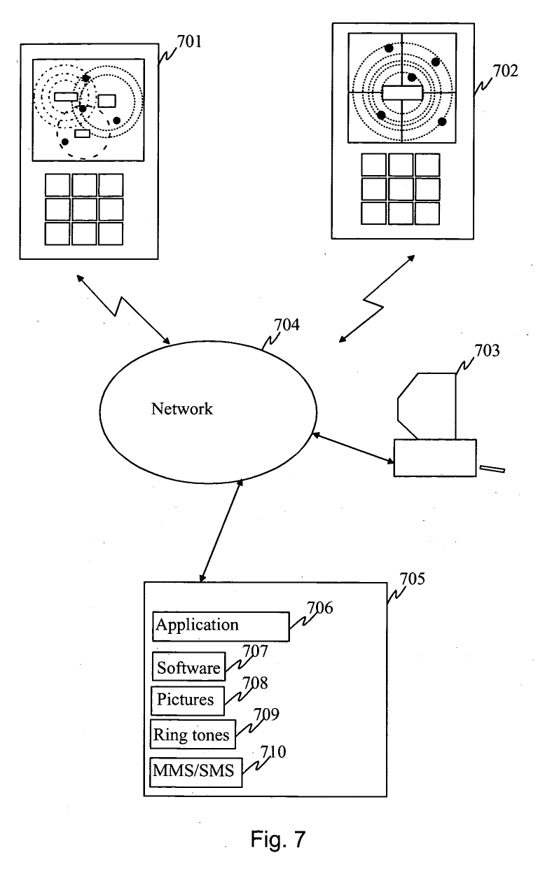

FIG. 7 illustrates a system according to an embodiment of the invention;

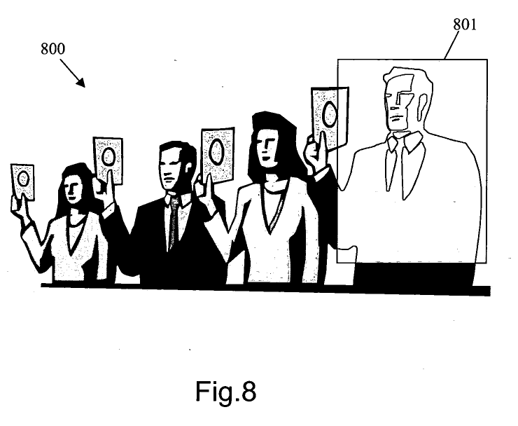

FIG. 8 illustrates a further embodiment of the invention where sub-metadata context can be used.

### DESCRIPTION OF FURTHER EMBODIMENTS

The present inventions now will be described more fully hereinafter with reference to the accompanying drawings, in which some, but not all embodiments of the invention are shown. Indeed, these inventions may be embodied in many different forms and should not be construed as limited to the embodiments set forth herein; rather, these embodiments are provided so that this disclosure will satisfy applicable legal requirements.

While a primary use of the further embodiments may be in the field of mobile phone technology, it will be appreciated from the following description that the invention is also useful for many types of devices that are generally referenced herein as mobile terminals, including, for example, handheld data terminals and personal data assistants, portable medical devices, personal multimedia units such as video or audio players (e.g., MP3 players), handheld PC devices, digital cameras, digital camcorders, portable TV devices, computer watches, and other portable electronics, including devices that are combinations of the aforementioned devices. Similarly, one of ordinary skill in the art will recognize that, while the further embodiments are particularly useful for devices with small screens and limited physical user interfaces, the embodiments can be used for searching or managing data files on other devices and systems.

One aspect of the further embodiments is the use of metadata in searches to determine or partially determine search results. As used herein, metadata means both the traditional data identified as metadata fields in data files such as description field and tagged information and also traditional non-metadata field information such as a file name, time stamp, and other information related to the data file, including a log of actions that are related to or that have been applied to the file, whether included as part of the data file or stored separately such as in an external database. Metadata is intended to mean the collective total of all information associated with the data file. For example, an image data file would include an image but the metadata related to the file would also include all other information related to the image, including metadata stored in the data file such as EXIF or IPTC fields inside a JPEG image file. Further, metadata may include text include in a data file such as a multimedia message where a sender provides text explaining where and attached image was captured; similar location metadata may be stored in metadata fields associated with the attached image data file. By way of further explanation and example, an image data file may have associated metadata including a file name, file size, date and time, description, image resolution and size, image type, and copyright information separate and apart from the image itself.

One of ordinary skill in the art will also recognize that further embodiments may be used for other applications apart from mobile devices such as searching on the Internet. The dynamic searching and refinement of searching may be used for other applications such as messaging or email and media such as music and video files. Embodiments of the present invention provide additional features for various management applications of multiple data files. For example, in a messaging or email system, messages may be searched based upon the various characteristics or metadata of the emails such as title or subject, sending, recipient, date, and message body to search and cluster the messages that would be otherwise searched and provided in a resulting flat list of messages. In general, the further embodiments may be utilized to manage and search any type or kind of file.

In the following various further embodiments of the invention will be disclosed in a practical level by referring to FIGS. 1-7.

There may be several data items on the display acting as a search criteria as illustrated in FIG. 1, wherein a display 100 of an electronic device provides search results of a search of data files according to an embodiment of the present invention. Several data items 101, 103, and 106, each having certain power of attraction, are attracting multimedia objects 110, 111.

The data item 101 comprises a name parameter “Person” having a parameter value “John Doe”. Around said data item 101 is located an area 102 inside of which the parameter value “John Doe” is true and outside of which the parameter value is false.

The data item 103 comprises a location parameter “Location” and it has two different parameter values called a city value “Tampere” and a country value “Finland”. Around said data item 103 is located an area 104 inside of which the city value “Tampere” and the country value “Finland” are true and outside of which the city value is false. Around the area 104 is a second area 105 inside of which the country value is true and outside of which the country value is false.

The data item 106 comprises a date parameter “Date” having three different parameter values called a day value “13”, a month value “JUL” and a year value “2003”. Around said data item 106 is located an area 107 inside of which all of the values “13”, “JUL” and “2003” are true and outside of which the day value is false. Around the circle 107 is a second circle 108 inside of which the month value and the year value are true and outside of which the month value is false. Around the circle 108 is a third circle 109 inside of which the year value is true and outside of which the year value is false.

The device provides to the user two multimedia objects 110, 111, as visual symbols such as graphical symbols on the display of the device, on the basis of the search the user has made with the previously mentioned parameter values. The user can easily note that the multimedia object 110 matches by the values of year and country. Respectively the user notes that the multimedia object 111 has much closer similarity. There is a match on the following parameter values: “Person”, “month”, “year” and location parameters “city” and “country”.

In various embodiments the visual symbols appearing on the display of the device are graphical symbols depicting as a presentation the level of attractiveness to the determined characteristics by the metadata. For example, the objects having enough level of attractiveness can be shown within an area. For another example the objects having enough level attractiveness can be shown so that the distance with respect to the center point illustrates the level of attractiveness on the display. Furthermore the object(s) having enough level of attractiveness may be marked or highlighted. Furthermore the object(s) having enough level of attractiveness can be shown so that user's attention is intuitively focused to that object(s).

Alternatively there may be only one data item on the display acting as search criteria as illustrated in FIG. 2, wherein a display 200 of an electronic device provides search results of a search of data files according to an embodiment of the present invention. A single data item 201 is attracting multimedia objects 205 and 206, each having several parameters of attraction. The data item 201 comprises three parameters “Person”, “Date” and “Location”. Said parameters are in sake of simplicity the same as were used in the illustration of FIG. 1. On the display 200 there are three circles 202-204 forming areas on the display 200. Each area represents the similarity of the metadata between the data item 201 and the multimedia objects 205 and 206. For example the area inside circle 202 may correspond to full similarity between the data item 201 and a multimedia object, in this case the multimedia object 205. On the area between the circles 202 and 203 two out of three parameters may match, the date and the location, for example. On the area between the circles 203 and 204 one out of three parameters may match, the location, for example. On the area outside the circle 204 there is no match between the data item and a multimedia object.

Alternatively the display screen may be divided to sectors, wherein each sector represents different parameter of attraction. FIG. 3 illustrates an alternative embodiment of displaying search results of a search of data files according to an embodiment of the present invention. A single data item 301 is attracting multimedia objects 305 and 306, having several parameters of attraction, each parameter has own sector of effect: Location 309, Time 310 and Person 311. The circles 302-304 and the areas inside and outside the circles have equivalent functionality or purpose compared to those circles and areas illustrated in FIGS. 1 and 2.

FIG. 4 illustrates a block diagram of an electronic device 400 according to an embodiment of the invention. The device 400 comprises a processor 401 and a memory 402 for processing the operations being performed in the device 400. The device may also comprise a storage medium 403 for storing applications and information, e.g. a phonebook 404, pictures 405, applications 406, such as the computer program product according to the present invention, and messages 407, like SMS and/or MMS messages. The device 400 further comprises a keyboard and a display for inputting and outputting information from and to the user of the device. The device 400 is connectable to a communication network and/or to another devices by means of a transceiver 410, an antenna 411 and an Input/Output means 412 and 413 e.g. an infrared connection and/or cable connection, such as an USB-, Bluetooth, Serial- or FireWire connection, for example.

The device 400 is preferably a wireless communication device, for example a mobile terminal operating in a wireless network, such as a GSM terminal that may further have other communication capabilities like Bluetooth, infrared or WLAN connection means. The present invention is not restricted to use in a device mentioned above. Also another electronic devices handling and transferring information to another electronic devices can be used instead such as PDA (Personal Digital Assistant) or a mobile computer such as a palm held device. The device can be further or alternatively a portable game console capable of providing to the user games stored in the memory 403 of the device 400. By aid of transceiver 410 and antenna 411 or Input/Output means 413 it is possible to connect the device 400 in communication connection with one or several other portable devices or servers.

FIG. 5 illustrates a flow chart of a method according to a further embodiment of the invention. The steps of the method can be implemented for example in a computer program code stored in a memory of an electronic device. When explaining this method a reference has been made to the device 400 being illustrated in FIG. 4 and to the display 200 being illustrated in FIG. 2.

When a user starts up the device, the association software is started either manually by the user or automatically by the device (step 501). The device 400 provides on the display to the user ability to select a file being stored in the memory of the device. When the user selects a file being stored in the memory of the device 400, the process according to the embodiments may also alternatively activate automatically at this step. If the user wants to select more than one file, the process repeats steps 502 and 503 until it proceeds to step 504.

Next at step 504 all the data files stored in the memory of the device are checked by the loop 504-507. One by one the files are selected (step 504), their metadata is compared (step 505) to the metadata of the files selected at step 502, the difference of the metadata is calculated i.e. the similarity of the metadata between the files is transformed into a measurable form. The similarity may be defined by means of a distance measure. There are several different calculation methods the can be used in this case.

Until all of the files in the memory have been checked the process proceeds to step 508, wherein the location of the data files on the display is calculated. At step 509 the data files are set on the display of the device as being illustrated in FIG. 2. The user may select a new file, in this case either multimedia object 205 or 206, and the process proceeds beck to step 502 and a new search is made on the basis of the selected file. If the user of the device does not want to select a new file at step 510, the process proceeds to step 511 and it ends.

FIG. 6 illustrates a flow chart of a method according to another further embodiment of the invention. The steps of the method can be implemented for example in a computer program code stored in a memory of an electronic device. When explaining this method a reference has been made to the device 400 being illustrated in FIG. 4 and the display 100 being illustrated in FIG. 1.

At step 601 the process according to the embodiment of the invention is started manually by the user of the device 400 or automatically by the device 400. At step 602 on the display of the device 400 there may be a selection of different data items for the user to select, a date, a location, or a name of a person, for example, as being illustrated in FIG. 1. At step 603 there is a possibility to refine value, i.e. to focus the search. The user of the device may want to set the parameters of the data item (step 604), e.g. by setting the day, month or year parameter values of the data item 106 in FIG. 1. At step 605 the user may decide whether he/she wants to select more than one data item to be used in the process. If more than one data item is selected, the process repeats loop 602-605 until no more selections are made.

Next at step 606 all the data files stored in the memory of the device are checked by the loop 606-609. One by one the files are selected (step 606), their metadata is compared (step 607) to the metadata of the data items selected at steps 602-605, the difference of the metadata is calculated (step 608) i.e. the similarity of the metadata between the files is transformed into a measurable form. The similarity may be defined by different calculation methods. For example a percentage value of matching metadata items may be calculated.

Until all of the files in the memory have been checked the process proceeds to step 610, wherein the location of the data files on the display is calculated. At step 611 the data files are set on the display of the device as being illustrated in FIG. 1. The user may select a file located on the display (step 612), in this case either multimedia object 110 or 111, and the process proceeds to step 502 on FIG. 5 and a new search is made on the basis of the selected file. If the user of the device does not want to select a new file at step 612, the process proceeds to step 613, wherein the user may decide, whether to make another search by selecting new data items (step 602) or end the process (step 614).

It will be understood that each block, or step, or element of the flowcharts of FIGS. 5 and 6, and combinations of blocks and/or elements in the flowchart, support combinations of means and combinations of steps for performing the specified functions. Similarly, it will be understood that each block, or step, or element of the flowcharts of FIGS. 5 and 6 and combinations of blocks and/or elements in the flowcharts, can be implemented by computer program instructions as noted above. These computer program instructions may be loaded onto a computer or other programmable apparatus to produce a machine, such that the instructions which execute on the computer or other programmable apparatus create means for implementing the functions specified in the flowchart block(s) or element(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowchart block(s) or element(s). The computer program instructions may also be loaded onto a computer or other programmable apparatus to cause a series of operational steps to be performed on the computer or other programmable apparatus to produce a computer implemented process such that the instructions which execute on the computer or other programmable apparatus provide steps for implementing the functions specified in the flowchart block(s) or element(s). It will also be understood that each block or element of the flowchart, and combinations of blocks and/or elements in the flowchart, can be implemented by special purpose hardware-based computer systems which perform the specified functions or steps, or combinations of special purpose hardware and computer instructions.

FIG. 7 illustrates a system according to an embodiment of the invention. The system now presented comprises a first wireless terminal device 701, e.g. a mobile telephone, a second wireless terminal 702, e.g. a PDA device, and a wire line device 703 such as a personal computer. The system further comprises a server 705 for providing services to the terminals 701 and 702 and to the device 703. The terminals 701 and 702 and the device 703 are capable to make a communication connection with each other and to the server 705 via the network 704. The system is preferably a mobile communication system, such as for example a GSM system. Alternatively the system may be or comprise other systems than GSM, such as WLAN, UMTS, WCDMA or 4G systems. The system is disclosed by a following example wherein a process according to the present invention is made between the terminals 701 and 702, the device 703 and the server 705.

At first the interaction is disclosed between the wireless terminal 701 and/or 702 and the server 705. The terminal devices 701 and 702 are similar than the device 400 illustrated in FIG. 4 previously. By the aid of the computer program product according to the present invention and the communication connection capability, the devices are able to search, browse and filter data files that are stored in the memory of the server 705. The server 705 preferably comprises the computer program product application 706 according to the present invention and may further comprise other data files such as software 707, pictures 708, ring tones 709 or messages, MMS and/or SMS messages, 710. The terminal device may perform the search process with the server 705, as it would search the memory of its own. Alternatively there may be delegation in the tasks to be performed. For example the terminal device 701 or 702 may only send a request to the server 705, which request comprises a file name and its metadata information. On the basis of the request the server then searches the files and performs necessary calculations the terminal device needs for setting the information on the display. This kind of task sharing is advantageous, since it saves the recourses and battery capacity of the terminal device.

The interaction is not restricted to previously mentioned embodiments between terminal devices and servers. Also the device 703, such as a personal computer is able to make a communication connection to the server 705 and to make search by the method according to the further embodiments. An advantageous embodiment would be searching of information from the Internet.

In accordance with various further embodiments of the invention, the search, also alternatively referred to as the query, can be focused. Thus once a first search for the selected characteristics has been made, the search results can be focused. For example, the weighting parameters can be amended etc. For another example, new or additional objects can be added among the group of objects defining the characteristics. For another example, new ones can replace the objects defining the current query.

In another further embodiments of the invention, the metadata characteristics can be weighted with respect to each other. The weighting of the metadata is determined in the calculation process to give more emphasis for the respectful characteristics the metadata represents or is related to. Thus adjusting the weighting of parameters emphasizes the respective characteristic(s) that the metadata represents. For example, the user can choose that location parameter is not interesting but people parameter is interesting. For another example, the location can be determined to be more important characteristic than time. The selected characteristics affect to the calculation process when determining the relation between the selected data item and the searched data item.

A secondarily context can be applied in the calculation and determination processes. Basically every object, i.e. data file, is displayed after the metadata query has been made with respect to the primarily searched object or a group of the primarily selected search objects. However, in cases there is determined, or as a result of the search found, a secondarily object, the query results are shown with respect the secondarily found object, which is closest or close enough to the primarily selected object. This option can be shown to user that the query result is displayed only with respect to the secondarily object. For example, an attribute “people” can also contain “related people”. This means that if “Pete” and “Anne” are metadata items of several files, and they have a relation. If the user chooses a file including only “Pete” as metadata item, the system still could view files where “Anne” is stored as metadata item, since Pete and Anne are related (e.g. in terms of file management).

Various further embodiments of the invention are described in connection with the entire object, e.g. a picture as a whole. However, it should be noted that the invention is not limited to such but metadata characteristics can only relate to a portion of the object, for example, a portion of the picture. Thereby various further embodiments provide a sub-object context. Various further embodiments of the invention relates to method for accessing and utilizing sub-picture metadata. There are multiple ways of implement this process regarding the technology used for user interface. For example a touch screen enabled mobile device can be used. The various embodiments can be based on the following process. The user opens a digital image including sub-picture metadata. FIG. 8 depicts an example of various further embodiments applying sub-metadata context. In the FIG. 8 a picture 800 is shown. The picture 800 shows four persons. A person 801 is associated with metadata. Thus the person 801 is identifiable by the characteristics of the metadata it has. The metadata is sub-metadata in the example because the metadata relates only to the person 801. For example the characteristics of the other persons can be ignored. The user touches the image 800, e.g. a display, by a finger or a pen, for example. The image 800 gets activated. The area(s) 801 where sub-picture metadata is stored becomes visible. The user touches twice, i.e. double click, the sub-picture metadata area 801 by finger or pen, which activates search based on the metadata items stored. Search engine of the device searches all the images and other multimedia material stored in the mobile based on the similar metadata. In the example of FIG. 8, all material including the picture 801 as metadata item, sub-picture metadata item or filename are searched. There are several ways to implement the further embodiments. The mobile device can be a touch-screen enable device. The touch-screen enabled mobile device comprises a touch screen, an image viewer, software enabling sub-picture metadata input, software treating the sub-picture metadata as active area including search function and a search engine that can be launched by touching twice the sub-picture area.

It should be noted that the location as use herein in the various further embodiments does not necessary refer to a named place only. Alternatively, the location can also mean X and Y coordinates in numbers which allows calculation of geographical distance. Furthermore the location can be used to calculate the distance of the files on a display.

The above disclosure illustrates the implementation of the invention and its embodiments by means of examples. A person skilled in the art will find it apparent that the invention is not restricted to the details of the above-described embodiments and that there are also other ways of implementing the invention without deviating from the characteristics of the invention. The above embodiments should thus be considered as illustrative and not restrictive. Hence the possibilities of implementing and using the invention are only restricted by the accompanying claims and therefore the different alternative implementations of the invention, including equivalent implementations, defined in the claims also belong to the scope of the invention.

1. A method for searching a data item from a plurality of data items each having at least one associated metadata item, the metadata being readable at a memory of an electronic device, wherein the electronic device comprises a user interface, characterized in that the method comprises;
selecting at least one data item as a search criteria,
calculating a relation between the metadata of the selected data item and at least one data item of said plurality of data items, and
providing the user interface with a first visual symbol about the at least one selected data item and with a second visual symbol about the at least one data item of the plurality of data items so that the first and the second visual symbols are placed with respect to each other in accordance with the calculated relation.

2. A method according to claim 1, wherein the step of selecting comprises selecting a data file having at least one metadata item, which data file is stored in the memory of the device.

3. A method according to claim 1, wherein the step of selecting comprises selecting a data item having at least one adjustable metadata item, which metadata item is stored in the memory of the device.

4. A method according to claim 1, wherein the relation is calculated as an amount of matching metadata items between the selected data file and said plurality of data items.

5. A method according to claim 1, wherein the relation is calculated based on a distance of the metadata items between the selected data file and the plurality of data files.

6. An electronic device for searching a data item from a plurality of data items each having at least one associated metadata item, the metadata item being readable at a memory of the electronic device, characterized in that the device comprises;
selecting means for selecting at least one data item as a search criteria,
calculating means for calculating a relation between the metadata of the selected data item and at least one data item of said plurality of data items,
a display for providing the user interface with a first visual symbol about the at least one selected data item and with a second visual symbol about the at least one data item of the plurality of data items so that the first and the second visual symbols are placed with respect to each other in accordance with the calculated relation.

7. A device according to claim 6, wherein the metadata is configured to establish a content magnet so that the at least one data item of the plurality of data items is attracted to the selected data item based on the metadata.

8. A device according to claim 6, wherein the metadata is configured to establish a level of attractiveness in accordance with the distance.

9. A device according to claim 7, wherein contents of the data items is configured to establish the metadata.

10. A device according to claim 6, further comprising several selected data items as a search criteria so that a center area of the selected data item defines a reference based on which the relation is determined.

11. A device according to claim 6, further comprising several visual symbols about plurality of data items so that several distances with respect to the first visual symbol can be provided.

12. A device according to claim 6, wherein said selecting means are configured to select the data item as a data file comprising at least one metadata item and being stored in the memory of the device.

13. A device according to claim 6, wherein said selecting means are configured to select the data item as a data item having at least one adjustable metadata parameter and being stored in the memory of the device.

14. A device according to claim 6, wherein said calculation means are arranged to calculate the relation as an amount of matching metadata items between selected data item and said plurality of data items.

15. A device according to claim 6, wherein the relation is calculated based on a distance of the metadata items between the selected data file and the plurality of data files.

16. A device according to claim 6, wherein said device comprises a mobile phone.

17. A device according to claim 6, wherein the metadata comprises a weight factor for identifying a level of importance of said metadata.

18. A device according to claim 6, wherein the device further comprises means for focusing the search criteria after a first search result is provided.

19. A device according to claim 6, wherein said metadata comprises a sub-metadata so that said sub-metadata is configured to relate only to the selected data item among other data items provided with the display.

20. A device according to claim 6, wherein the visual symbols comprises graphical symbols so that they graphically determine the calculated relation.

21. A system for searching a data item from a plurality of data items each having at least one associated metadata item, the metadata item being readable at a memory of an electronic device, characterized in that the system comprising;
selecting means for selecting at least one data item as a search criteria,
calculating means for calculating a relation between the metadata of the selected data item and at least one data item of said plurality of data items,
a display for providing the user interface of the device with a first visual symbol about the at least one selected data item and with a second visual symbol about the at least one data item of the plurality of data items so that the first and the second visual symbols are placed with respect to each other in accordance with the calculated relation.

22. A computer program product for an electronic device for searching a data item from a plurality of data items each having at least one associated metadata item, the metadata item being readable at a memory of the electronic device, characterized in that the computer program product comprises;
a computer program code for causing the device to select at least one data item as a search criteria,
a computer program code for causing the device to calculate a relation between the metadata of the selected data item and at least one data item of said plurality of data items, and
a computer program code for causing the device to provide the user interface of the device with a first visual symbol about the at least one selected data item and with a second visual symbol about the at least one data item of the plurality of data items so that the first and the second visual symbols are placed with respect to each other in accordance with the calculated difference.
